(19) United States
(12) Patent Application Publication
(10) Pub. No.: US 2009/0299818 A1
(43) Pub. Date: Dec. 3, 2009

(54) METHODS FOR MERCHANDISING DIGITAL CONTENT

(76) Inventors: Raoul Heinze, Vancouver, WA (US); Stevan Miles Arychuk, Vancouver, WA (US); Melanie Robertson, Camas, WA (US); Rajeev Pandey, Corvallis, OR (US); David M. Hall, Camas, WA (US); Yevgeniy Eugene Shteyn, Cupertino, CA (US); John H. Sturgeon, Camas, WA (US); Michael L. Niquette, Vancouver, WA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/259,851

(22) Filed: Oct. 28, 2008

Related U.S. Application Data
(60) Provisional application No. 61/130,060, filed on May 28, 2008.

(51) Int. Cl. G06Q 10/00

(52) U.S. Cl. 705/10

(57) ABSTRACT

A method for merchandising digital content of an event includes measuring consumer attention level in the event and comparing the measured consumer attention level to a predetermined threshold. The method also includes predicting a time after the event at which the consumer attention level in the event will fall below a critical level and estimating the time needed for processing digital content of the event. Merchandising of digital content is initiated if the measured consumer attention level exceeds the predetermined threshold and the predicted time at which the consumer attention level will fall below a critical level is greater than the estimated content processing time.

### BACKGROUND OF THE INVENTION

Distribution of various types of video content (e.g., theatrical movie releases, DVD sales, television series) are highly advertisement-driven and season-driven. For example, major movie studios spend up to 50% of a movie budget on marketing and advertisement of a new movie. Furthermore, to maximize sales, movies and DVDs are commonly released to coincide with holiday shopping seasons, summer vacations, the Academy Awards, etc. Most of the time, release events are conducted on a national scale. This is a very expensive distribution strategy that does not allow for cost-efficient (low budget) distribution of video content that is of interest to smaller audiences or user communities over a wide variety of dates.

On the other hand, media-on-demand (MOD) distribution systems provide for a very flexible content release schedule for various niche audiences. However, niche demand must be sufficient to recover content storage, processing, shipping and other costs for MOD systems to be profitable.

### DESCRIPTION OF THE DRAWINGS

FIG. 1 is a flow chart depicting one embodiment of a process for merchandising digital content.

FIG. 2 is a graph depicting a predicted demand curve.

### DETAILED DESCRIPTION OF THE INVENTION

The present invention generally relates to a system or process for merchandising digital content (e.g., DVDs, Blu-Ray discs, flash drives, downloads, streaming, peer-to-peer delivery, etc.) that provides timed delivery of content that is relevant to particular user groups. The process predicts critical levels of demand for locally relevant content (i.e., content that is relevant or of interest to a particular user or “niche” group) and orchestrates acquisition, processing, and merchandising of the content. The process is applicable to media-on-demand (MOD) environments as well as distribution via Internet, brick-and-mortar and other outlets.

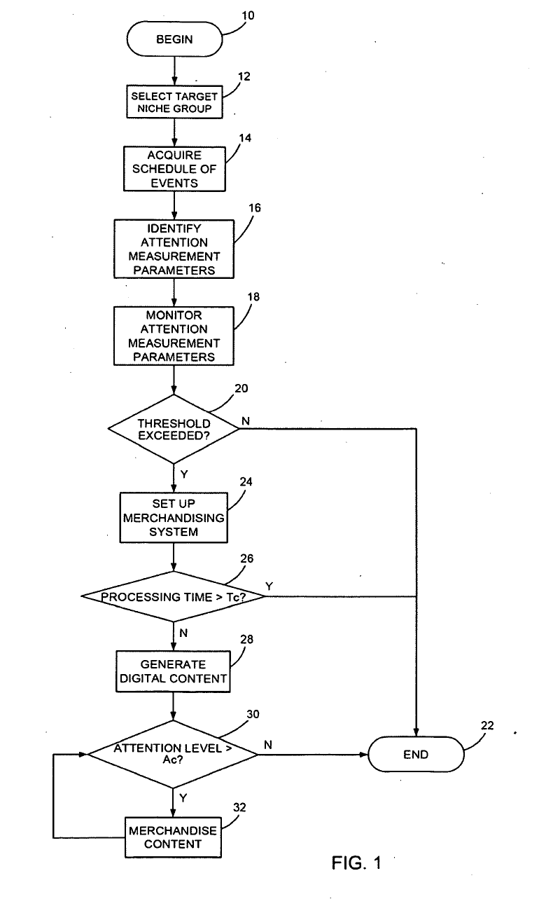

Referring to the drawings, FIG. 1 is a flow chart depicting one embodiment of a process for merchandising digital content. The process begins at block 10 and proceeds to block 12 where a niche group to target with a content merchandising system is identified and selected. As used herein, the term “niche group” refers to any group of people/consumers joined by some common bond. This can include people residing in a common geographic location (e.g., a community, city, state, region, etc.) and can also include a group of people that may reside in geographically diverse locations but share a common interest, hobby, occupation, educational institution, etc. Niche groups can also include virtual environments such as an online computer role-playing game, a social network, etc. By way of example, a niche group can be selected from a database of retail stores, such as Safeway, Wal-Mart, and Lucky, or high-traffic kiosk areas, such as airports, shopping malls, concert halls, etc. In another example, a niche group can be selected from a set of online virtual community members, such as Second Life, Facebook, Myspace, World of Warcraft, etc.

The next step is to acquire a schedule of events for the selected niche group, as shown at block 14. More specifically, the process identifies one or more “target events,” i.e., events, such as future entertainment events, that might be suitable for merchandising digital content of to the selected niche group. This can be accomplished by parsing, either manually or automatically, various web sites or data feeds for one or more keywords pertaining to the selected niche group and matching events to the keyword or keywords. For example, if the selected niche group was the geographic location of the State of Oregon, then web sites could be parsed for the keyword “Oregon.” Possible events that could be found by this technique and added to the schedule of events for the selected niche group might include college football games for the University of Oregon. In another example, a pre-defined event profile machine-readable attributes in an electronic format is created and distributed to MOD systems prior to schedule compilation. In one embodiment where the niche group is containing a geographic location, the event schedule can contain machine-readable location codes for each event. These location codes could comprise, for example, U.S. zip codes or other public or proprietary location identifiers. Multiple location codes could be associated with a single event. For example, a football game between the University of Oregon and the University of Houston may contain codes for both Portland, Oreg. and Houston, Tex.

Furthermore, for each event added to the schedule of events, the date and time of the event, as well as keywords and potential parameters for attention monitoring are extracted and associated with the event. Preferably, the events in the schedule of events are associated with metadata that lists relevant event information. Using the college football game example, the metadata could include historical attendance figures, historical merchandise sales, number of season ticket holders, number of alumni, scores, player information, rivalries, venue information, television ratings, online attention, recommended search terms, associated community URIs, etc.

At block 16, the next step is to identify parameters related to consumer interest and which can be used for measuring the consumer attention level for each event listed in the schedule of events. For example, such parameters may include the number of search engine requests with search terms relevant to the event, the number of messages from unique users on a relevant community messaging board and/or blog, the number of unique reads from a relevant community messaging board and/or blog, the number of previously qualified purchases of digital content for similar events, the number of visitors to online locations, battles with game characters, etc. Some of this data can be purchased directly from search engine service providers; also, software is available for monitoring web sites and virtual environments. The purpose of identifying relevant consumer attention parameters is to create a system for measuring consumer interest in the event. This measuring system can also be used to predict what the demand for digital content of the event will be after the event occurs.

The next step, at block 18, is to begin monitoring the identified parameters for each event listed in the schedule of events to measure the consumer attention level for each event. Furthermore, the monitored parameters can be mapped to determine from where the consumer interest is coming. While this monitoring may begin as soon as the parameters are identified, the system may delay the start of the monitoring until after a predetermined time interval passes. If there is a monitoring delay, the length of the predetermined time interval will depend on the timing of the particular event. For example, if an event to be monitored is scheduled to occur well into the future, monitoring can be delayed until closer to the time of the event. Generally, attention parameter levels will be monitored for some period of time before the time of the event. Alternatively, if the system detects a spike of activity within a monitored location and/or community, it may initiate a search for merchandisable content related to the event that caused the spike.

Next, at block 20, while the parameter levels are being monitored prior to the time of an event, the measured consumer attention levels for each event are compared to certain threshold values. Generally, the threshold values are set based on experience, knowledge and historical data. This step provides an indication as to whether there is a sufficient level of interest in the event to support producing digital content of the event. The goal is to make a decision on whether to initiate a content merchandising process. If the attention parameter levels for any one of the events being monitored do not exceed the threshold values (indicating an insufficient level of interest in that event), the process ends with respect to that event as shown at block 22. In other words, monitoring of that event is discontinued and no merchandising of digital content of the event will occur. If the attention parameter levels for any of the events being monitored does exceed the threshold values (indicating a sufficient level of interest in that event), then a merchandising system is set up for each such event, at block 24.

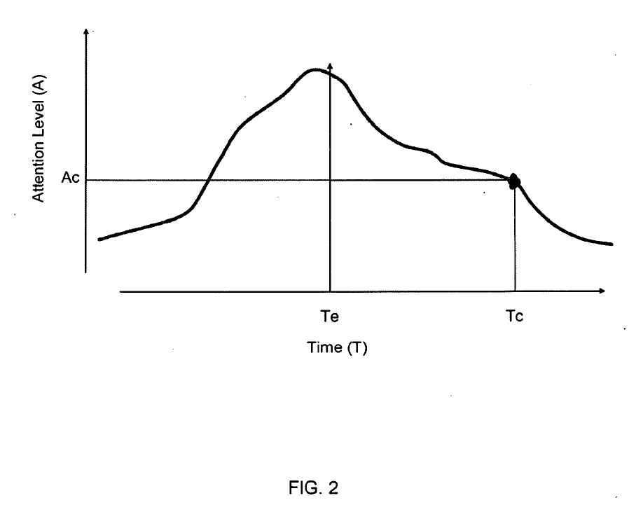

Setting up a merchandising system for an event comprises continuing to monitor consumer attention parameters (in the manner as described above) for the event and using this information to predict the demand level over time for digital content of the event. Aggregated actual user interest data is acquired to predict a “profitable attention interval” with respect to the event. Generally, the predicted demand level can be represented by a time-dependent demand curve. FIG. 2 shows a sample demand curve in the form of a graph having a vertical axis denoting predicted consumer attention level (wherein consumer demand is directly correlated to consumer attention) and a horizontal axis denoting time. This demand curve shows that the predicted consumer attention level steadily increases in the time before the event and reaches a peak just before or at the time of the event, Te. The predicted consumer attention level begins to decrease after the event and eventually reaches a time, referred to herein as the critical time, Tc, at which the attention level falls below the critical attention level, Ac. The critical attention level, Ac, is the minimum attention level for which there is sufficient interest in the event to support merchandising digital content of the event. The interval between the time of the event, Te, and the critical time, Tc, represents the “profitable attention interval.”

Returning to FIG. 1, setting up a merchandising system for an event (block 24) also includes estimating the time needed to process digital content of the event. Content processing time may include content acquisition (acquisition of legal rights and physical assets), content production (transcoding, manufacturing of media such as DVDs), content distribution (transmission, shipping, shelving), and other operations. Next, at block 26, a determination is made as to whether there is sufficient time to process the digital content in view of the predicted demand level. If the estimated content processing time for an event is greater than the critical time Tc, then monitoring of that event is discontinued and no merchandising of digital content of the event will occur, as shown at block 22. If the estimated content processing time for an event is less than the critical time Tc, then the content preparation process is initiated at block 28. This content preparation process can include initiating a localized advertisement campaign to stimulate demand for the content.

The consumer attention level for the event is continually monitored while the content preparation process is running. The consumer attention parameters are monitored in the manner as described above. At block 30, a decision is made as to whether there is sufficient consumer interest to proceed with the merchandising system for the event. If the measured attention level falls below the critical attention level, Ac, then monitoring of the event is discontinued and no merchandising of digital content of the event will occur, as shown at block 22. But as long as the measured attention level exceeds the critical attention level, Ac, then digital content for that event is merchandised as shown at block 32. Consumer attention for the event is continually monitored while the digital content is being merchandised, and merchandising of the content is continued until the measured attention level falls below the critical attention level, Ac, at which point the process will end with respect to that event, as shown at block 22.

The system can identify outlets (e.g., Internet sites, brick-and-mortar stores, mobile network segments, online virtual environments, servers, etc.) where content could be profitably merchandised. The system may also calibrate sales at different merchandising locations and shift inventory or distribution patterns, based on consumer attention and demand. In the case where the merchandising system operates a network of kiosks or similar retail outlets, content replacement recommendations can be generated. In another embodiment, wherein a content kiosk is connected to a content delivery network, the system may download more relevant content into the kiosk's local storage and purge obsolete items. In a yet another embodiment, content is moved between geographically dispersed servers that support a virtual environment.

Content generation may include various content manipulation operations, such as transcoding, transrating, DRM encoding, insertion of promotional content (e.g., advertisements, coupons, etc.), and insertion of software and data components (e.g., scripts, widgets, references, markers, tracking modules, niche group specific content, etc.). In one example a video feed of an HDTV broadcast is converted to a Blu-Ray compatible format. In another example, a satellite TV MPEG-2 stream is transcoded into one of MPEG-4 formats for mobile and P2P distribution. In a yet another example a graphics feed from a battle tournament in the virtual environment of World of Warcraft is converted into a DVD-CCA compatible format.

While specific embodiments of the present invention have been described, it should be noted that various modifications thereto could be made without departing from the spirit and scope of the invention as defined in the appended claims.

What is claimed is:

1. A method for determining whether to merchandise digital content of an event, said method comprising:
measuring consumer attention level in said event;
comparing said measured consumer attention level to a predetermined threshold;
predicting a time after said event at which the consumer attention level in said event will fall below a critical level;
estimating content processing time for digital content of said event; and
deciding to initiate a content manufacturing process if said measured consumer attention level exceeds said predetermined threshold and said predicted time at which the consumer attention level in said event will fall below a critical level is greater than said estimated content processing time.

2. The method of claim 1 wherein measuring consumer attention level in said event includes monitoring one or more parameters related to consumer interest in said event.

3. The method of claim 2 wherein one of said parameters includes the number of search engine requests with search terms relevant to said event.

4. The method of claim 2 wherein one of said parameters includes the number of unique users of a community messaging board or blog relevant to said event.

5. The method of claim 1 wherein estimating content-processing time for digital content of said event includes estimating time needed for content acquisition, content production and content distribution.

6. A method for merchandising digital content, said method comprising:
identifying a target niche group to merchandise digital content to;
identifying one or more events relating to said niche group;
determining a level of interest for each event;
for each event that has a level of interest that exceeds a predetermined threshold, predicting a profitable attention interval;
for each event that has a level of interest that exceeds a predetermined threshold, estimating content processing time; and
initiating merchandising of digital content for each event that has a profitable attention interval that is greater than the content processing time.

7. The method of claim 6 further comprising, for each event for which merchandising of digital content has been initiated, monitoring the level of interest in said event and discontinuing merchandising of digital content for any such event for which the level of interest falls below a critical level.

8. The method of claim 6 wherein determining a level of interest for each event monitoring one or more parameters related to consumer interest in each event.

9. The method of claim 8 wherein one of said parameters includes the number of search engine requests with search terms relevant to said event.

10. The method of claim 8 wherein one of said parameters includes the number of unique users of a community messaging board or blog relevant to said event.

11. The method of claim 6 wherein identifying one or more events relating to said niche group includes parsing web sites for one or more keywords pertaining to said niche group and matching events to said keywords.

12. The method of claim 11 further comprising, for each event, extracting the date and time of the event.

13. The method of claim 11 further comprising associating relevant event metadata with each event.

14. The method of claim 6 wherein predicting a profitable attention interval includes predicting the time after the event at which the level of interest in the event will fall below a critical level.

15. The method of claim 6 wherein estimating content processing time includes estimating time needed for content acquisition, content production and content distribution.
